(19) United States
(12) Patent Application Publication
(10) Pub. No.: US 2006/0072537 A1
(43) Pub. Date: Apr. 6, 2006

(54) System for providing wireless internet mobile communication service and method of the same

(76) Inventors: Don Lee, Kyungki-do (KR); Chan-Koo Jeon, Daejeon-city (KR)

Correspondence Address: John W Renner;Renner Otto Boisselle & Sklar, 1621 Euclid Avenue, 19th Floor, Cleveland, OH, 44115, US

(21) Appl. No.: 10/544,242

(22) PCT Filed: Feb. 3, 2004
(86) PCT No.: PCT/KR04/00192

§ 371 Date: Aug. 2, 2005

(30) Foreign Application Priority Data
Feb. 3, 2003 (KR) 10-2003-0006642
Feb. 3, 2004 (KR) 10-2004-0006829

(51) Int. Cl. H04J 3/24

(52) U.S. Cl. 370/349

(57) ABSTRACT

Provided are a system and method for providing wireless Internet mobile communication service. A channel allocator allocates a communication channel to an Internet mobile station when the Internet mobile station transmits a call requesting message to an Internet mobile switching center system or when the Internet mobile switching center system transmits the call requesting message to the Internet mobile station. An address allocator allocates a rental IP address to the Internet mobile station, transmits address allocation information of the Internet mobile station, withdraws the rental IP address from the Internet mobile station when mobile communication between the Internet mobile station and a counterpart Internet mobile station ends, and informs the Internet mobile switching center system of the withdrawal of the rental IP address. A call controller receives an IP address of the counterpart Internet mobile station from the Internet mobile switching center system, transmits the IP address of the counterpart Internet mobile station to the Internet mobile station, and relays speech IP packets between the Internet mobile station and the counterpart Internet mobile station via a communication channel of the Internet mobile station.

### TECHNICAL FIELD

The present invention relates to a system and method for providing a wireless Internet mobile communication service, and more particularly, to a system and method for providing a wireless Internet mobile communication service using an Internet Protocol (IP) packet.

### BACKGROUND ART

Internet-based communication service includes personal computer (PC)-to-PC service, PC-to-Phone service, Phone-to-Phone service, and so on. In PC-to-PC service, a personal computer (PC) executes an Internet phone program to call a counterpart PC, which executes an Internet phone program, via the Internet. PC-to-Phone service provides communication between a phone and a PC via an Internet phone switching system (Gateway) of an Internet access service provider. Phone-to-Phone service provides communication between phones via a Gateway that is installed over phone and Internet networks. As a modification of PC-to-PC service, IP phone-to-IP phone service provides communication between IP phones, which are connected to the Internet, by executing Internet phone programs in the IP phones that include micro-controllers.

There has been suggested a wireless Internet mobile communication technology which provides communications by accessing the Internet through an Access Point (AP) via a wireless local area network (LAN). The wireless Internet mobile communication technology includes the following disclosures: Korean Patent Publication Nos. 2001-54322 (Title of the Invention: Wireless Internet Phone), 2002-0042107 (Title of the Invention: Wireless Internet Telephone Communication and Internet Phone for Wireless Internet Data Communication), 2002-0030701 (Title of the Invention: Internet Phone System and Method Using Personal Digital Assistant), and Korean Utility Model No. 20-0276694 (Title of the Invention: Wireless LAN Internet Phone with USB Connector).

However, such a conventional Internet mobile phone is only able to communicate with another Internet mobile phone within a limited zone. Even when using a wireless AP adopting an 802.11b wireless IP, a communication range of the Ethernet in the wireless LAN is 100 m, and a communication range of the Bluetooth is 10 m or less. Therefore, wireless Internet mobile communication service cannot be provided continuously. In other words, unlike code division multiple access (CDMA) mobile phone technology which provides free mobile communication service, the conventional wireless Internet mobile communication service is provided within a limited area around an AP.

### DISCLOSURE OF THE INVENTION

The present invention provides an Internet base station system which provides a mobile phone user with communication service via the Internet at all times and locations.

The present invention also provides an Internet mobile switching center system which provides a mobile phone user with communication service via the Internet at all times and locations.

The present invention also provides an Internet mobile communication terminal which provides a mobile phone user with communication service via the Internet at all times and locations.

The present invention also provides a mobile phone user with wireless Internet mobile communication service via the Internet at all times and locations.

The present invention also provides a computer-readable recording medium on which a program is recorded to execute the wireless Internet mobile communication service in a computer.

According to an aspect of the present invention, there is provided an Internet base station system including: a first communication unit which transmits data to and receives data from an Internet mobile station; a second communication unit which transmits data to and receives data from an Internet mobile switching center system and an Internet home location register system; a storage unit which stores its own Internet Protocol address and at least one or more rental Internet Protocol addresses which are allocatable to the Internet mobile station; a channel allocation unit which allocates a communication channel to a sending Internet mobile station when the sending Internet mobile station transmits a call requesting message to the Internet mobile switching center system via the first communication unit or when the Internet mobile switching center system transmits the call requesting message to a receiving Internet mobile station; an address allocation unit which allocates a rental Internet Protocol address to the sending Internet mobile station, transmits address allocation information comprising identification information and the rental Internet Protocol address of the Internet mobile station, and the Internet Protocol address of the storage unit to the Internet mobile switching center system, withdraws the rental Internet Protocol address from the sending Internet mobile station when mobile communication between the sending Internet mobile station and the receiving Internet mobile station ends, and informs the Internet mobile switching center system of the withdrawal of the rental IP address; and a call controller which receives an Internet Protocol address of the receiving Internet mobile station from the Internet mobile switching center system, transmits the Internet Protocol address of the receiving Internet mobile station to the sending Internet mobile station, and relays speech Internet Protocol packets between the sending Internet mobile station and the receiving Internet mobile station via the communication channel of the sending Internet mobile station.

According to another aspect of the present invention, there is provided a An Internet mobile switching center system including: a first communication unit which transmits data related to registration of and a request for Internet Protocol address information to and receives the data from an Internet base station system; a second communication unit which transmits data related to the request for the Internet Protocol address information to and receives the data from an Internet home location register system which is connected thereto; a storage unit which stores address rental information comprising identification information of the Internet mobile station, an Internet Protocol address of the Internet base station system, and/or an IP address allocated to the Internet mobile station by the Internet base station system; an address manager which stores first address rental information comprising the identification information of the Internet mobile station, which goes into a coverage area of the Internet base station system, and the IP address of the Internet base station system in the storage unit, deletes the first address rental information from the storage unit when receiving a request for deletion of the first address rental information from the Internet base station system, stores second address rental information comprising the identification information of the Internet mobile station, the IP address of the Internet base station system, and a rental Internet Protocol address of the Internet mobile station in the storage unit, and deletes the second address rental information from the storage unit when receiving a request for withdrawal of the rental IP address of the Internet mobile station from the Internet base station system; and a call controller which searches for the storage unit based on identification information of a receiving Internet mobile station received from a sending Internet base station system, transmits a busy tone to the sending Internet mobile station when the storage unit stores an Internet Protocol address and a rental Internet Protocol address of a receiving Internet base station system corresponding to the identification information of the receiving Internet mobile station, instructs the receiving Internet base station system to allocate a communication channel and a rental Internet Protocol address to the receiving Internet mobile station when the storage unit stores only the Internet Protocol address of the receiving Internet base station system corresponding to the identification information of the receiving Internet mobile station, transmits the rental Internet Protocol address of the receiving Internet mobile station received from the receiving Internet base station system to the sending Internet base station system, and transmits the rental Internet Protocol address of the sending Internet mobile station to the receiving Internet base station system.

According to still another aspect of the present invention, there is provided a method of providing a wireless Internet mobile communication service, including: (a) when a call requesting message is received from a first Internet mobile station or the call requesting message is transmitted from an Internet mobile switching center system to the first Internet mobile station, allocating a communication channel to the first Internet mobile station; (b) allocating a rental Internet Protocol address to the first Internet mobile station and transmitting address allocation information comprising identification information and the rental Internet Protocol address of the first Internet mobile station, and an Internet Protocol address and identification information of a second Internet mobile station which is a corresponding Internet mobile station of the first Internet mobile station to the Internet mobile switching center system; (c) transmitting the Internet Protocol address of the second mobile station from the Internet mobile switching center system to the first Internet mobile station; (d) relaying speech Internet Protocol packets between the first Internet mobile station and the second Internet mobile station via a communication channel allocated to the first Internet mobile station; and (e) when speech communication between the first Internet mobile station and the second Internet mobile station ends or a handoff for the first Internet mobile station and/or the second Internet mobile station is performed, withdrawing the rental Internet Protocol address from the first Internet mobile station and/or the second Internet mobile station and informing the Internet mobile switching center system of the withdrawal of the rental IP address from the first Internet mobile station and/or the second Internet mobile station.

According to yet another aspect of the present invention, there is provided a method of providing a wireless Internet mobile communication service, including: (a) storing first address allocation information which includes identification information of an Internet mobile station received from an Internet base station system and an Internet Protocol address of the Internet base station system and/or second address allocation information which includes identification information of the Internet mobile station, an Internet Protocol address of the Internet base station system, and a rental Internet Protocol address of the Internet mobile station in an address rental database; (b) searching the address rental database based on identification information of a receiving Internet mobile station received from a sending Internet base station system, transmitting a busy tone to the sending Internet base station system when the address rental database retains an Internet Protocol address and a rental Internet Protocol address of a receiving Internet base station system corresponding to the identification information of the receiving Internet mobile station, instructing the receiving Internet base station system to allocate a communication channel and a rental Internet Protocol address to the receiving Internet mobile station when the address rental database retains only the Internet P address of the receiving Internet base station system corresponding to the identification information of the receiving Internet mobile station, transmits the rental Internet Protocol address of the receiving Internet mobile station from the receiving Internet base station system to the sending Internet base station system, and transmits the rental Internet Protocol address of the sending Internet mobile station to the receiving Internet base station system; and (c) when the Internet base station system requests withdrawal of the rental Internet Protocol address of the Internet mobile station, deleting the address allocation information corresponding to the Internet mobile station from the address rental database.

According to yet another aspect of the present invention, there is provided an Internet mobile communication terminal including: a speech processor which converts an input speech signal into an electric signal or the electric signal into the speech signal; a keypad which receives a command from a user; a communication controller which transmits a call requesting message to an Internet base station system that is connected to a wireless Internet network, using a predetermined protocol, is assigned a communication channel and an Internet Protocol address from the Internet base station system to establish a communication path, and transmits its identification information to the Internet base station system in response to a paging signal that is broadcast by the Internet base station system; and a packet processor which generates Internet protocol packets from digital speech and video data and command data input from a keyboard based on the rental Internet Protocol address allocated by the Internet base station system, and restores the Internet protocol packets to digital speech and video data and character data.

### BRIEF DESCRIPTION OF THE DRAWINGS

The above and other aspects and advantages of the present invention will become more apparent by describing in detail preferred embodiments thereof with reference to the attached drawings in which:

FIG. 1 is a view for showing the whole structure of a wireless Internet mobile communication phone system, according to the present invention;

FIG. 2 is a block diagram of an Internet mobile station;

FIG. 3 is a view for showing the configuration of a wireless Internet mobile communication network which includes cells managed by a plurality of Internet base station servers;

FIG. 4 is a block diagram of an Internet base station system, according to a preferred embodiment of the present invention;

FIG. 5 is a block diagram of an Internet mobile switching center server, according to a preferred embodiment of the present invention;

FIGS. 6A and 6B are flowcharts for explaining a method of providing a wireless Internet mobile communication service, according to a preferred embodiment of the present invention; and

FIG. 7 is a flowchart for explaining a method of performing a handoff process during a wireless Internet mobile communication service, according to a preferred embodiment of the present invention.

### BEST MODE FOR CARRYING OUT THE INVENTION

Hereinafter, preferred embodiments of the present invention will be described in detail with reference to the attached drawings.

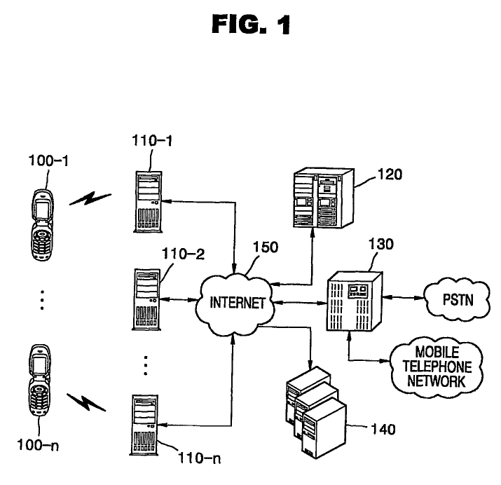

FIG. 1 shows the whole configuration of a wireless Internet mobile communication system, according to the present invention. Referring to FIG. 1, the wireless Internet mobile communication system includes Internet mobile stations (IMSs) 100-1 through 100-n, Internet base stations (IBSSs) 110-1 through 110-n, an Internet mobile switching center server (IMSCS) 120, a gateway system 130, and an Internet home location register server (IHLRS) 140.

The IBSSs 110-1 through 110-n, the IMSCS 120, the gateway system 130, and the IHLRS 140 are connected via Internet 150. A plurality of wireless Internet mobile communication systems may be connected in parallel via the Internet 150 to constitute a domestic or international wireless Internet mobile communication network.

The IMSs 100-1 through 100-n transmit and receive data packets using an IP during moving. The IMSs 100-1 through 100-n may be mobile Internet phones, personal digital assistants (PDAs), or notebooks.

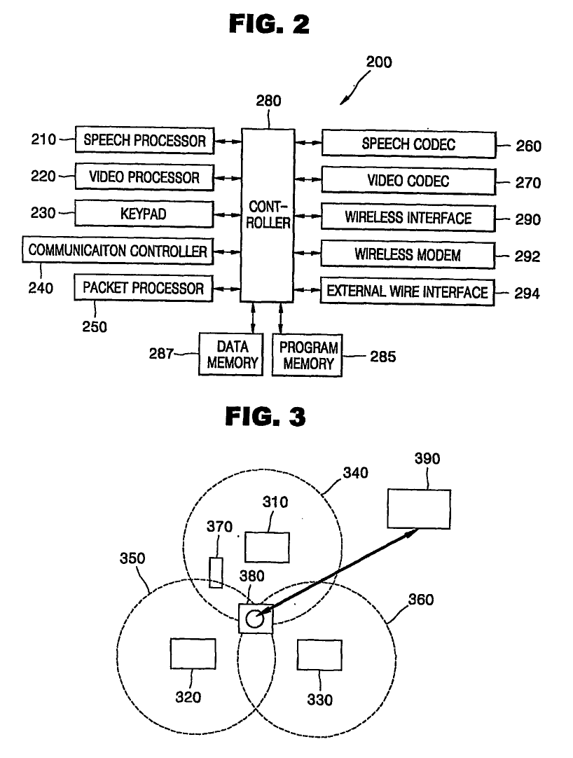

FIG. 2 is a block diagram of an IMS 200. Referring to FIG. 2, the IMS 200 includes a speech processor 210, a video processor 220, a keypad 230, a communication controller 240, a packet processor 250, a speech codec 260, a video codec 270, a controller 280, a program memory 285, a data memory 287, a wireless interface 290, a wireless modem 292, and an external wire interface 294.

The speech processor 210 includes a microphone and a speaker. The microphone converts a speech signal into an electric signal, and the speaker converts the electric signal into audible speech and outputs the audible speech. The video processor 220 includes a camera and a display. The camera converts a video into an electric signal, and the display displays a visible video or character signal. The keypad 230 receives figures, characters, and the like from a user.

The communication controller 240 transmits an access message to the IBSSs 110-1 through 110-n according to H.323, Session Initiation Protocol (SIP), MGCP, MEGACO standards, and other protocols, and is assigned a communication channel and an IP address from the IBSSs 110-1 through 110-n to establish a communication path. The communication controller 240 transmits its own identification (ID) information to the IBSSs 110-1 through 110-n in response to a paging signal broadcast by the IBSSs 110-1 through 110-n.

The packet processor 250 generates an Internet Protocol (IP) packet from digital speech and video data and command data input from a keyboard based on a rental IP address allocated by the IBSSs 110-1 through 110-n.

The IP packets are transmitted to the IBSSs 110-1 through 110-n via the wireless interface 290 and the wireless modem 292.

The packet processor 250 also receives the IP packets from the IBSSs 110-1 through 110-n and restores the IP packet to digital speech and video and other character data. The digital speech data, the digital video data, or the other character data are output via the speech processor 210 or the video processor 220.

The speech codec 260 converts the speech signal that is input via the microphone into a digital speech signal or the digital speech signal into the electric signal and provides the speech digital signal or the electric signal to the speaker. The speech codec 260 codes, compresses, and decodes the digital speech according to G.0711, G723.1, G726, G729, and other standards. The video codec 270 converts the video signal that is input via the camera into the digital video data or the digital video and character data into the video signal and provides the display with the converted data.

The controller 280 controls the IMS 200. The controller 280 also controls the speech codec 260 so as to output the digital speech data to the speaker, and controls the video codec 270 so as to output the digital video and character data to the display. The controller 280 communicates with the IBSSs 110-1 through 110-n in response to a user's command.

The program memory 285 stores a control program which is used by the controller 280, and the data memory 287 stores electronic serial numbers (ESNs) and phone numbers of the IMSs 100-1 through 100-n which are used for authenticating each of the IMSs 100-1 through 100-n. The wireless interface 290 interfaces the controller 280 and the wireless modem 292, and the wireless modem 292 modulates and/or demodulates the IP packet into a radio frequency (RF) signal to transmit and receive the modulated and/or demodulated signal via a communication channel which is assigned by the IBSSs 110-1 through 110-n. The external wire interface 294 interfaces the IMSs 100-1 through 100-n with an external wire network.

The IBSSs 110-1 through 110-n and the-IMSCS 120 are core components necessary for providing a wireless Internet mobile communication service.

FIG. 3 is a view for showing the configuration of a wireless Internet mobile communication network which includes cells managed by a plurality of IBSSs. Referring to FIG. 3, IBSSs 310, 320, and 330 manage cells 340, 350, and 360, respectively. In the present invention, a cell is referred to as a service zone, which is managed by one IBSS, as in mobile communication technology that is presently commercialized. The size of the cell may depend on the density of subscribers. In general, the size of the cell decreases with an increase in the density of the subscribers. The shape of the cell is generally circular but depends on the surroundings. The IBSS 310, which manages the cell 340 in which an IMS 370 is located, assigns a rental IP address to the IMS 370 via a communication channel allocated to the IMS 370, transmits an IP packet to and receives the IP packet from the IMS 370. When a plurality of IMSs are located in a cell, an IBSS, which manages the corresponding cell, allocates communication channels and rental IP addresses to the IMSs, respectively, to transmit IP packets to and receive the IP packets from the IMSs wirelessly, so as to perform speech and data communications. The IBSSs 310, 320, and 330 are connected to an IMSCS 390 via an Internet network 380.

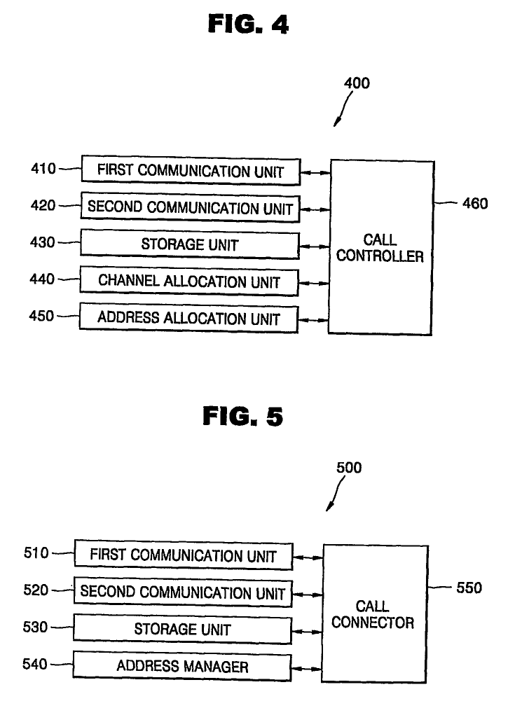

FIG. 4 is a block diagram of an IBSS, according to a preferred embodiment of the present invention. Referring to FIG. 4, an IBSS 400 includes a first communication unit 410, a second communication unit 420, a storage unit 430, a channel allocation unit 440, an address allocation unit 450, and a call controller 460.

The first communication unit 410 transmits data to and receives data from the IMSs 100-1 through 100-n. The first communication unit 410 includes a wireless antenna which transmits and receives an RF signal, a modulator and demodulator which modulates and demodulates the RF signal, and a multiplexer and demultiplexer which multiplexes and demultiplexes the RF signal. A modulation and demodulation method for an RF signal and a multiple access method, which is used by the first communication unit 410, are well known to those of ordinary skill in the art and thus will be briefly described herein. 802.11b Internet mobile communication technology presently supports 11 Mbps in a 2.4 GHz band to guarantee the mobility of a user, and CDMA, FDMA, TDMA, OFDM, and combinations of CDMA, FDMA, TDMA, and OFDM may be used as a multiple access method.

The second communication unit 420 transmits data to and receives data from the IMSCS 120 and the IHLRS 140 via an Internet network.

The storage unit 430 stores an IP address allocated to the IBSS 400 and at least one or more rental IP addresses which are allocatable to the IMSs 100-1 through 100-n. It is preferable that the number of rental I addresses is at least greater than a channel capacity of the IBSS 400. An operation program used for controlling and managing the operation of the IBSS 400 is installed in the storage unit 430. The storage unit 430 includes system and data memories for the installation of the operation program.

When the IMSCS 120 receives a call requesting message from one of the IMSs 100-1 through 100-n via the first communication unit 410 or transmits the call requesting message to one of the IMSs 100-1 through 100-n, the channel allocation unit 440 allocates communication channels to the corresponding IMS. The call requesting message includes ID information of a sending IMS and ID information of receiving IMS. The ID information of the IMS includes phone numbers and ESNs of the IMS.

When the sending IMS transmits the call requesting message to the IMSCS 120, the IMSCS 120 provides the ID information of the receiving IMS to IBSSs to instruct the lower IBSSs to transmit a paging signal to the receiving IMS. The IBSSs transmit the paging signal to check whether the receiving IMS is within their coverage. When the lower IBSSs receive a response to the paging signal from the receiving IMS, they inform the IMSCS 120 that the receiving IMS is within their coverage. Channel allocation unit of the corresponding IBSS allocates communication channel to the receiving IMS.

When the lower IBSSs do not inform the IMSCS 120 that the receiving IMS is within their coverage, the IMSCS 120 provides another IMSCS with the ID information of the receiving IMS to instruct another IMSCS to transmit a paging signal.

The address allocation unit 450 allocates rental IP address to the sending IMS to which the communication channel has been allocated, and stores the ID information of the sending IMS and the rental IP address to link the ID information to the rental IP address. The address allocation unit 450 also transmits address allocation information including the ID information and rental IP address of the sending IMS and the IP address of the IBSS 400 to the IMSCS 120. When speech communication between the sending IMS and receiving IMS ends, the address allocation unit 450 withdraws the rental IP address from the sending IMS and informs the IMSCS 120 of the withdrawal.

The call controller 460 transmits IP address of the receiving IMS received from the IMSCS 120 to the sending IMS, and relays speech IP packets between the sending IMS and the receiving IMS via the communication channel allocated to the sending IMS. When the call controller 460 receives the call requesting message from the sending IMS, the call controller 460 requests the IMSCS 120 to allocate communication channel and rental IP address to the receiving IMS based on ID information of the receiving IMS, and transmits the rental IP address of the receiving IMS to the sending IMS. When an adjacent IBSS takes over a function of managing the sending IMS by performing handoffs for the sending IMS, the call controller 460 instructs the channel allocation unit 440 and the address allocation unit 450, respectively, to release the communication channel and withdraw the rental IP address from the sending IMS to disconnect calls.

The channel allocation unit 440 releases the communication channel from the sending IMS during the handoffs for the sending IMS. The address allocation unit 450 withdraws the rental IP address from the sending IMS during the handoffs for the sending IMS, and then informs the IMSCS 120 of the withdrawal.

The handoffs are initiated by the IMSs 100-1 through 100-n or the IBSS 400. When the handoffs are initiated by the IMSs 100-1 through 100-n, the IMSs 100-1 through 100-n request the handoffs when the intensity of an electric wave received from the IBSS 400 is lower than a predetermined reference value. When the handoffs are commenced by the IBSS 400, the call controller 460 performs the handoffs. Here, when the intensity of signals received from the IMSs 100-1 through 100-n is lower than a predetermined reference intensity, the call controller 460 requests the IMSCS 120 for the handoffs. The IMSCS 120 selects one of IBSSs adjacent to the IBSS 400 to manage the IMSs 100-1 through 100-n. When the IMSCS 120 informs the call controller 460 that the handoffs are completed, the call controller 460 instructs the channel allocator 440 and the address allocator 450 to release the communication channels and withdraw the rental IP addresses.

The IHLRS 140 manages information related to the IMSs 100-1 through 100-n, and authenticates the IMSs 100-1 through 100-n based on the ID information of the IMSs 100-1 through 100-n received from the IMSCS 120. Table 1 shows an example of a database managed by the IHLRS 140.

TABLE 1

| | | | |
|---|---|---|---|
| Phone Number | ESN of | Usage Fee Payment | Personal Details |
| of IMS1 | IMS1 | Information of IMS1 | of Subscriber 1 |
| Phone Number | ESN of | Usage Fee Payment | Personal Details |
| of IMS2 | IMS2 | Information of IMS2 | of Subscriber 2 |
| . | . | . | . |
| . | . | . | . |
| . | . | . | . |
| Phone Number | ESN of | Usage Fee Payment | Personal Details |
| of IMS3 | IMS3 | Information of IMS3 | of Subscriber 3 |
| Overseas Phone | — | IP Address of IHLRS | — |
| Number or | | or Gateway System | |
| Phone Number | | Corresponding to | |
| of other | | Overseas Phone | |
| communication | | number | |
| networks | | | |

The database shown in Table 1 includes phone numbers and ESNs of IMSs, which have subscribed to a communication service, payment information for usage of the IMSs, and personal details of subscribers corresponding to the IBSSs. The database further includes an overseas phone number or phone number of other communication networks and IP addresses of an overseas IHLRS corresponding to overseas phone number or phone number of other communication networks.

The IHLRS 140 registers and withdraws the IMSs 100-1 through 100-n, manages the ID information (phone numbers and ESNs) of the IMSs 100-1 through 100-n, authenticates the IMSs 100-1 through 100-n, provides the IMSCS 120 with the address allocation information of the IMSs 100-1 through 100-n, processes overseas phone numbers and phone numbers within a public switched telephone network (PSTN), processes roaming, and manages payments of usage fees. The IHLRS 140 may include lower IHLRSs which manage their zones and higher IHLRSs which manage the lower IHLRSs.

FIG. 5 is a block diagram of an IMSCS, according to a preferred embodiment of the present invention. Referring to FIG. 5, an IMSCS 500 includes a first communication unit 510, a second communication unit 520, a storage unit 530, an address manager 540, and a call connector 550.

The first communication unit 510 transmits data related to registration of and a request for IP address information to the IBSSs 110-1 through 110-n and receives the data from the IBSSs 110-1 through 110-n. The second communication unit 520 transmits data related to a request for the IP address information to the IHLRS 140 and receives the data from the IHLRS 140.

The storage unit 530 stores the address allocation information including ID information and IP addresses of the IBSSs 110-1 through 110-n and the rental IP addresses of the IMSs 100-1 through 100-n allocated by the IBSSs 110-1 through 110-n. Table 2 shows an example of the address allocation information stored in the storage unit 530 of the IMSCS 500.

TABLE 2

| | | | |
|---|---|---|---|
| Phone Number | ESN of | IP Address of | Rental IP Address |
| of IMS1 | IMS1 | IBSS1 | of IMS1 |
| Phone Number | ESN of | IP Address of | Rental IP Address |
| of IMS2 | IMS2 | IBSS2 | of IMS2 |
| . | . | . | . |
| . | . | . | . |
| . | . | . | . |
| Phone Number | ESN of | IP Address of | Rental IP Address |
| of IMSn | IMSn | IBSSn | of IMSn |
| Phone Number | — | IP Address of | — |
| of PSTN | | Gateway System | |
| Phone Number | — | IP Address of | — |
| of Mobile | | Gateway System | |
| Telephone | | | |
| Network (MTN) | | | |
| Overseas Phone | — | IP Address of | — |
| Number | | IHLRS | |

According to Table 2, the address allocation information includes the phone numbers and ESNs of the IMSs 100-1 through 100-n, the IP addresses of the IBSSs 110-1 through 110-n which manage the IMSs 100-1 through 100-n, and the rental IP addresses of the IMSs 100-1 through 100-n. The phone numbers and ESNs of the IMSs 100-1 through 100-n and the IP addresses of the IBSSs 110-1 through 100-n are written from when the IMSs 100-1 through 100-n enter the cells managed by the IBSSs 110-1 through 110-n to when the IMSs 100-1 through 100-n exit the cells. The rental IP addresses of the IMSs 100-1 through 100-n are written from when communication begins to when the communication ends.

The address allocation information further includes information as to phone numbers belonging to a phone number zone of the PSTN (or IDSN) and the MTN and an IP address of the gateway system 130 used for communication with subscribers of the PSTN and the MTN. When the IP address of the gateway system 130 is provided to the IMSs 100-1 through 100-n during communication between subscribers of the PSTN and a wireless Internet communication network, the IMSs 100-1 through 100-n transmit and receive speech and other data packets to and from the gateway system 130 via the Internet network. The address allocation information further includes information as to phone numbers belonging to overseas or other communication networks and an IP address of the IHLRS 140. When the IMSs 100-1 through 100-n requests a call requesting message for phone numbers belonging to the overseas or other communication networks, the IMSCS 120 receives rental IP addresses of the phone numbers in the overseas or other communication networks from the IHLRS 140 to provide the IMSs 100-1 through 100-n with the rental IP addresses, so as to enable communications between the IMSs 100-1 through 100-n and the phone numbers.

The address manager 540 stores the address allocation information including the ID information of the IMSs 100-1 through 100-n in the storage unit 530. When the IMSs 100-1 through 100-n informs the address manager 540 of the withdrawal of the rental IP addresses, the address manager 540 deletes the address allocation from the storage unit 530.

The address allocation information is stored according to two methods. In the first method, the address manager 540 stores the address allocation information when a specific IMS, for example, the IMS 100-1, enters or leaves a specific IBSS, for example, the IBSS 110-1. Here, the address manager 540 stores the ID information of the IMS 100-1 and the IP address of the IBSS 110-1 which manages the IMS 100-1. As a result, the IMSCS 120 can recognize IBSSs in which the IMSs 100-1 through 100-n are located. In the second method, the address manager 540 stores the rental IP address of the specific IMS, for example, the IMS 100-1, within the specific IBSS, for example, the IBSS 110-1. As a result, the IMSCS 120 can check whether the IMS 100-1 performs communications.

The call connector 550 searches the storage unit 530 based on ID information of a receiving IMS received from a sending IBSS. When the storage unit 530 includes address allocation information including the ID information of the receiving IMS, the call connector 550 transmits a rental IP address allocated to the receiving IMS to the sending IBSS and a rental IP address allocated to a sending IMS to a receiving IBSS. When the storage unit 530 does not include the address allocation information, the call connector 550 instructs the receiving IBSS to allocate a communication channel and an IP address to the receiving IMS. The call connector 550 transmits the rental IP address of the receiving IMS received from the receiving IBSS to the sending IBSS and the rental IP address of the sending IBSS to the receiving IBSS.

When the ID information of the receiving IMS belongs to ID information of an IMS within the PSTN or the MTN, the call connector 550 transmits the rental IP address of the sending IMS to the gateway system 130, which is connected to the PSTN or the MTN, and the IP address of the gateway system 130 to the sending IMS. When the ID information of the receiving IMS is not stored in the storage unit 530, the call connector 550 transmits the ID information of the receiving IMS to the IHLRS 140 to identify an IMSCS which manages an IBSS that manages the receiving IMS. The call connector 550 transmits the rental IP address of the receiving IMS received from the identified IMSCS to the sending IBSS and the rental IP address of the sending IMS to the receiving IBSS.

When an IBSS informs the address manager 540 that a rental IP address has been withdrawn from an IMS by performing a handoff for the IMS, the address manager 540 deletes IP address rental information of the IMS. The address manager 540 stores address allocation information of the IMS received from an adjacent IBSS, which has taken over a function of managing the IMS, in the storage unit 530. The address allocation information is received from an adjacent IBSS, which takes over a function of managing the IBSS that has undergone the handoff. Here, the call connector 550 provides a receiving IMS with a changed rental IP address of the IMS.

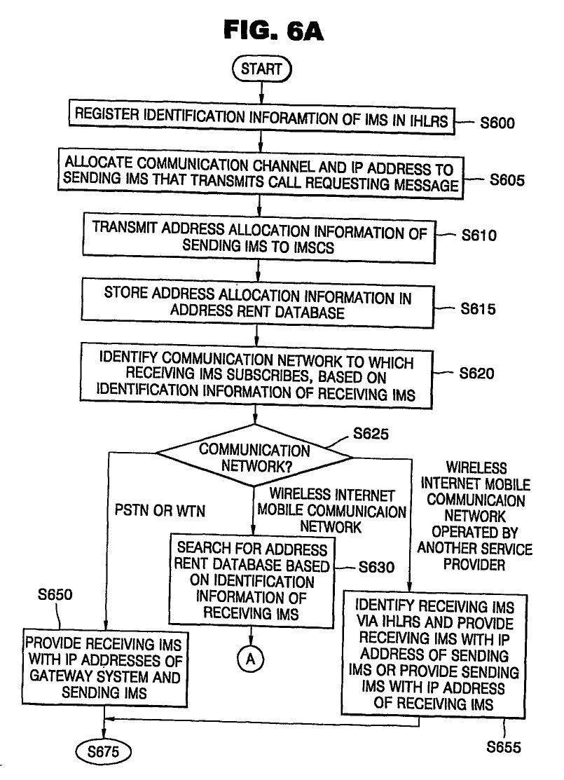

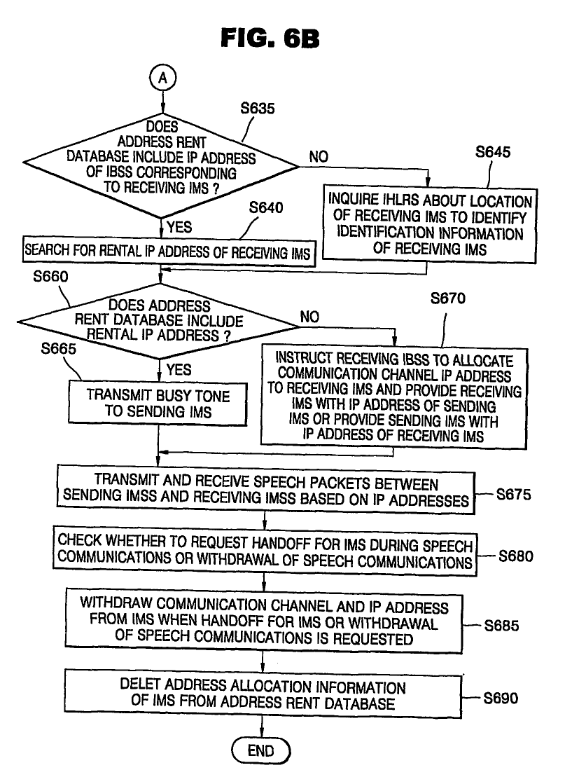

FIGS. 6A and 6B are flowcharts for explaining a method of providing a wireless Internet mobile communication service, according to a preferred embodiment of the present invention.

Referring to FIGS. 6A and 6B, when a user subscribes to a wireless Internet mobile communication service, a phone number is allocated to an IMS which is purchased by the user, and then the allocated phone number is stored in a memory of the IMS. In step S600, the phone number and an ESN of the IMS, and information concerning the subscriber (usage payment information, personal details, and so on) are registered in an IHLRS.

In step S605, when a sending IBSS receives a call requesting message from a sending IMS within its coverage, the sending IBSS allocates a communication channel and a rental IP address to the sending IMS. In step S610, the sending IBSS transmits address allocation information including ID information and the rental IP address of the sending IMS, and an IP address of the sending IBSS and ID information of a receiving IMS to an IMSCS.

In step S615, the IMSCS stores the address allocation information in an address rental database. The structure of the address rental database is as shown in Table 2. In step S620, the IMSCS identifies a communication network to which a receiving IMS subscribes, for example, a wireless Internet mobile communication network, a PSTN, a wireless telephone network (WTN), an international telephone network (ITN), and the like, based on ID information of the receiving IMS.

In step S625, the IMSCS determines whether the communication network is the wireless Internet mobile communication network. If in step 8625, it is determined that the communication network is the wireless Internet mobile communication network, in step S630, the IMSCS searches the address rental database for an IP address of an IBSS managing the receiving IMS, based on the ID information of the receiving IMS. In step S635, the IMSCS checks whether the address rental database includes the IP address of the IBSS, based on the ID information of the receiving IMS. The IMSCS can identify the IBSS managing the receiving IMS based on the checked IP address. If in step S635, it is determined that the address rental database includes the IP address of the IBSS, in step S640, the IMSCS searches the address rental database for a rental IP address corresponding to the ID information of the receiving IMS. In step S660, the IMSCS searches the rental IP, based on the ID information of the receiving IMS. If in step S635, it is determined that the address rental database does not include the IP address of the IBSS, in step S645, the IMSCS inquires of the IHLRS on the location of the receiving IMS, i.e., about information as to the IBSS managing a zone in which the receiving IMS is located, to identify the location of the receiving IMS.

If in step S660, it is determined that the address rental database includes the rental IP address corresponding to the ID information of the receiving IMS, in step S665, the IMSCS informs the sending IMS via the sending IBSS that the receiving IMS is performing a communication operation. If in step S660, it is determined that the address rental database does not include the rental IP address corresponding to the ID information of the receiving IMS, in step S670, the IMSCS instructs the receiving IBSS to allocate a communication channel and a rental IP address to the receiving IMS, provides the sending IMS with the rental IP address of the receiving IMS via the sending IBSS, and provides the rental IP address of the sending IMS to the receiving IMS via the receiving IBSS.

If in step S625, it is determined that the communication network is the PSTN or the WTN, in step S650, the IMSCS transmits the rental IP address of the sending IMS to a gateway system and provides the sending IMS with an IP address of the gateway system via the sending IBSS. If in step S625, it is determined that the communication network is a wireless Internet mobile communication network operated by another service provider, in step S655, the IMSCS transmits the ID information of the receiving IMS to an IHLRS within the wireless Internet mobile communication network to identify an IMSCS which manages the IBSS managing the receiving IMS. Also in step S655, the IMSCS receives the rental IP address of the receiving IMS from the identified IMSC and transmits the rental IP address of the receiving IMS to the sending IMS via the sending IBSS and the rental IP address of the sending IMS to the receiving IMS via the receiving IBSS.

In step S675, the sending IMS transmits speech packets to the receiving IMS to perform mobile communication. In step S680, the IBSS checks during mobile communication whether a handoff or communication withdrawal for an IMS is requested. If in step S680, it is determined that the handoff or communication withdrawal for the IMS has been requested, in step S685, the IBSS withdraws a communication channel and a rental IP address from the IMS and informs the IMSCS of the withdrawal. In step S690, the IMSCS deletes the address allocation information of the corresponding IMS from the address rental database.

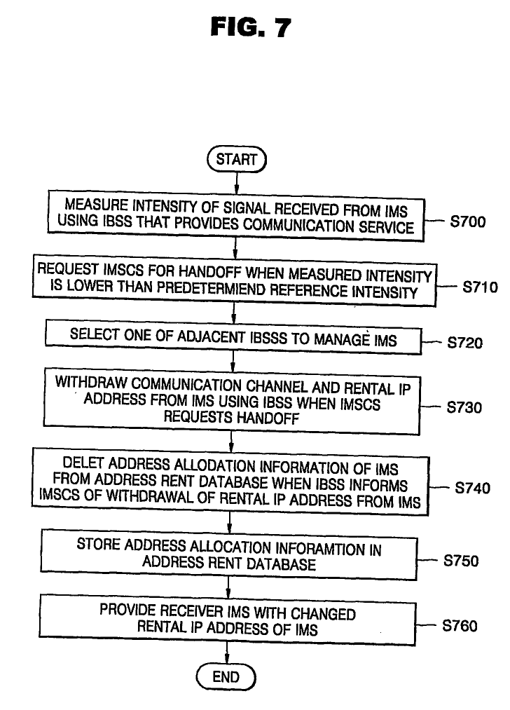

FIG. 7 is a flowchart for explaining a handoff process performed when a wireless Internet mobile communication service is provided, according to a preferred embodiment of the present invention.

Referring to FIG. 7, in step S700, an IBSS, which provides a communication service, measures the intensity of a signal received from an IMS. When the measured intensity is lower than a predetermined reference intensity, in step S710, the IBSS requests an IMSCS for a handoff. In step S720, the IMSCS selects one of the IBSSs adjacent to the IBSS to manage the IMS. Here, the IMSCS instructs the adjacent IBSSs to measure the intensity of signals received from the IMS and then selects an IBSS which has measured the most intensive signal.

In step S730, the IBSS withdraws the communication channel and the rental IP address from the IMS when the IMSCS instructs the IBSS to perform the handoff. In step S740, the IMSCS deletes address allocation information corresponding to the IMS from an address rental database when the adjacent IBSS informs the IMSCS of the withdrawal of the communication channel and the rental IP address. In step S750, the IMSCS stores the address allocation information in the address rental database. In step S760, the IMSCS transmits a changed rental IP address of the IMS to a receiving IMS.

Such an IMSCS performs major functions, i.e., call processing, traffic management, call transferring, and the like. The IMSCS can authenticate an IMS based on a phone number and an ESN of the IMS via an IHLRS which is connected to the IMSCS via the Internet. Each IBSS is controlled by the IMSCS which is connected to each IBSS via the Internet or a private network. Each IBSS transmits an RF signal via an antenna, and transmits and receives data packets to and from one another. A call transmission process is performed in order of a control channel scan, a connection determination, an origination message transmission, a channel allocation, and a communication. The IMS detects the most intensive signal from the adjacent IBSS through the control channel scan, determines to be connected to the adjacent IBSS, and transmits an origination message including a phone number of a receiving IMS which has dialed, and its own phone number and ESN to the determined IBSS. The IBSS authenticates the IMS via the IMSCS and allocates a communication channel and a rental IP address to the IMS. The IMS performs speech or data communication via the communication channel.

A call reception process is performed in order of an identification of the type of receiving IMS, paging, a response, a channel allocation, and communications. When a subscriber for a wireless Internet mobile communication service, a public switched telephone service, or a mobile telephone service calls a subscriber for the wireless Internet mobile communication service, the IMSCS determines to which communication network the phone number of the receiving IMS belongs. Here, the IMSCS instructs the IBSS to transmit a paging signal to identify the locations of the subscribers. Since the IMS continues monitoring the call of the IBSS, the IMS transmits its own ESN and phone number to the closest IBSS when its own phone number is called. The IBSS transmits the ESN and phone number of the IMS to the IMSCS to authenticate the IMS and allocates a communication channel and a rental IP address to the IMS. The IMS then generates a ring signal and informs a user of the incoming of the call.

It is highly possible for a wireless Internet mobile communication system to be wiretapped compared to a wire communication system. To prevent this, a wireless Internet mobile communication service provider allocates a phone number to an IMS of each subscriber and an IMS maker allocates an ESN to the IMS. The phone number of the IMS has the same phone system as a phone number of a subscriber for a wire communication service, and the ESN of the IMS cannot be changed. The phone number is allocated to the IMS when the IMS subscribes to the wireless Internet mobile communication service and is then registered with the ESN in the IHLRS.

The location of the IMS is registered in the following states.

1) Power-up Registration: Register the current state and location of the IMS when the IMS is powered up.

2) Power-down Registration: Register the state of the IMS when the IMS is powered down.

3) Time-based Registration: Register the location of the IMS periodically so that the IMS normally receives the wireless Internet mobile communication service.

4) Distance-based Registration: Register the location of the IMS when the IMS is far from the last registration point.

5) Zone-based Registration: Register a new zone to which the IMS moves.

6) Parameter-change Registration: Register parameters of the IMS which have been changed, i.e., a changed phone number and the like.

7) Order Registration: Order the IMS to register its location for lack of information for registering the location of the IMS although the IMSCS identifies the new zone in which the IMS is located.

8) Implicit Registration: Register the location of the IMS when the IMSCS implicitly identifies via a transmission or reception response that the IMS has moved to a new zone.

9) Traffic Channel Registration: Register the location of the IMS by the IMSCS itself when the IMS moves to a new zone through a handoff during communication.

The process of registering the location of the IMS in the wireless Internet mobile communication system is performed as follows.

The whole service zone (a zone allocated to the IHLRS) is divided into a plurality of zones in which positions of a plurality of calling IMSs are registered, i.e., zones managed by an IBSS, and each of the zones includes a group of cells covered by the IBSS. The location registration is to register the location of a subscriber roaming within a service zone in the IMSCS and is performed in the service zone by the IMSCS without the participation of the IHLRS.

When the subscriber roams in an adjacent zone, the location registration is performed as follows.

When the IMS moves to another zone and requests the registration of the changed location, the IMSCS receives parameters from the IHLRS to authenticate the IMS and registers the changed location of the IMS.

Hereinafter, an IMSCS in a new position registration zone in which roaming occurs is referred to as an IMSCS (A), and an IMSCS in a previous position registration zone is referred to as an IMSCS (B).

When the IMS requests the IMSCS (A) to update its location, the IMSCS (A) requests the IHLRS to update the location of the IMS. The IHLRS then requests the IMS for an authentication via the IMSCS (A), and the IMS responds to the request to inform the IHLRS of the completion of the authentication via the IMSCS (A). The IHLRS informs the IMS of the completion of the location updating via the IMSCS (A). Thereafter, the IHLRS requests the IMSCS (B) to delete information on a subscriber of the IMS, and the IMSCS (B) deletes the information and informs the IHLRS of the completion of the deletion. As a result, roaming is finished.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

In a system and method for providing wireless Internet mobile communication service, according to the present invention, video and character data can be transmitted even when a user is mobile. As a result, wireless Internet mobile communication service can be provided without pause at a low cost.

1. An Internet base station system comprising:
a first communication unit which transmits data to and receives data from an Internet mobile station;
a second communication unit which transmits data to and receives data from an Internet mobile switching center system and an Internet home location register system;
a storage unit which stores its own Internet Protocol address and at least one or more rental Internet Protocol addresses which are allocatable to the Internet mobile station;
a channel allocation unit which allocates a communication channel to a sending Internet mobile station when the sending Internet mobile station transmits a call requesting message to the Internet mobile switching center system via the first communication unit or when the Internet mobile switching center system transmits the call requesting message to a receiving Internet mobile station;
an address allocation unit which allocates a rental Internet Protocol address to the sending Internet mobile station, transmits address allocation information comprising identification information and the rental Internet Protocol address of the Internet mobile station, and the Internet Protocol address of the storage unit to the Internet mobile switching center system, withdraws the rental Internet Protocol address from the sending Internet mobile station when mobile communication between the sending Internet mobile station and the receiving Internet mobile station ends, and informs the Internet mobile switching center system of the withdrawal of the rental IP address; and
a call controller which receives an Internet Protocol address of the receiving Internet mobile station from the Internet mobile switching center system, transmits the Internet Protocol address of the receiving Internet mobile station to the sending Internet mobile station, and relays speech Internet Protocol packets between the sending Internet mobile station and the receiving Internet mobile station via the communication channel of the sending Internet mobile station.

2. The Internet base station system of claim 1, wherein the call controller performs a handoff process for the Internet mobile station and instructs the channel allocation unit and the address allocation unit to withdraw the communication channel and the rental Internet Protocol address from the Internet mobile station to disconnect a call when an adjacent Internet base station server takes over a function of managing the Internet mobile station; the channel allocation unit withdraws the communication channel from the Internet mobile station during the handoff for the Internet mobile station; and the address allocation unit withdraws the rental Internet Protocol address from the Internet mobile station during the handoff for the Internet mobile station and informs the Internet mobile switching center system of the withdrawal of the rental Internet Protocol address from the Internet mobile station.

3. The Internet base station system of claim 2, wherein when the call controller receives a request for the handoff from the Internet mobile station, the call controller instructs the channel allocation unit and the address allocation unit, respectively, to withdraw the communication channel and the rental Internet Protocol address

4. The Internet base station system of claim 2, wherein the call controller requests the Internet mobile switching center system for the handoff when an intensity of a signal received from the Internet mobile station is lower than a predetermined reference intensity, and the call controller instructs the channel allocation unit and the address allocation unit, respectively, to withdraw the communication channel and the rental Internet Protocol address when the Internet mobile switching center system selects one among a plurality of adjacent Internet mobile station systems to manage the Internet mobile station so as to complete the handoff.

5. The Internet base station system of claim 1, wherein the call requesting message comprises identification information of the sending Internet mobile station and identification information of the receiving Internet mobile station.

6. The Internet base station system of claim 1, wherein the identification information of the Internet mobile station comprises at least one of a phone number allocated to the Internet mobile station and an electronic serial number allocated to the Internet mobile station.

7. The Internet base station system of claim 1, wherein the address allocation unit allocates the rental Internet Protocol address to the Internet mobile station, and stores the rental Internet Protocol address and the identification information of the Internet mobile station in the storage to link the rental Internet Protocol address with the identification information.

8. The Internet base station system of claim 1, wherein when the call controller receives the call requesting message from the sending Internet mobile station, the call controller requests the Internet mobile switching center system to allocate the communication channel and the rental Internet Protocol address to the receiving Internet mobile station based on the identification information of the receiving Internet mobile station, and transmits the rental Internet Protocol address of the receiving Internet mobile station to the sending Internet mobile station.

9. An Internet mobile switching center system comprising:
a first communication unit which transmits data related to registration of and a request for Internet Protocol address information to and receives the data from an Internet base station system;
a second communication unit which transmits data related to the request for the Internet Protocol address information to and receives the data from an Internet home location register system which is connected thereto;
a storage unit which stores address rental information comprising identification information of the Internet mobile station, an Internet Protocol address of the Internet base station system, and/or an IP address allocated to the Internet mobile station by the Internet base station system;
an address manager which stores first address rental information comprising the identification information of the Internet mobile station, which goes into a coverage area of the Internet base station system, and the IP address of the Internet base station system in the storage unit, deletes the first address rental information from the storage unit when receiving a request for deletion of the first address rental information from the Internet base station system, stores second address rental information comprising the identification information of the Internet mobile station, the IP address of the Internet base station system, and a rental Internet Protocol address of the Internet mobile station in the storage unit, and deletes the second address rental information from the storage unit when receiving a request for withdrawal of the rental IP address of the Internet mobile station from the Internet base station system; and
a call controller which searches for the storage unit based on identification information of a receiving Internet mobile station received from a sending Internet base station system, transmits a busy tone to the sending Internet mobile station when the storage unit stores an Internet Protocol address and a rental Internet Protocol address of a receiving Internet base station system corresponding to the identification information of the receiving Internet mobile station, instructs the receiving Internet base station system to allocate a communication channel and a rental Internet Protocol address to the receiving Internet mobile station when the storage unit stores only the Internet Protocol address of the receiving Internet base station system corresponding to the identification information of the receiving Internet mobile station, transmits the rental Internet Protocol address of the receiving Internet mobile station received from the receiving Internet base station system to the sending Internet base station system, and transmits the rental Internet Protocol address of the sending Internet mobile station to the receiving Internet base station system.

10. The Internet mobile switching center system of claim 9, wherein:
when the Internet base station system informs the address manager of the withdrawal of the rental Internet Protocol address through a handoff process for a first Internet mobile station, the address manager deletes Internet Protocol address rental information corresponding to the first Internet mobile station, and stores the Internet Protocol address rental information of the first Internet mobile station received from an adjacent Internet base station system which takes over a function of managing the first Internet mobile station; and
the call controller which transmits a changed rental Internet Protocol address of the first Internet mobile station to a second Internet mobile station which is a corresponding Internet mobile station of the first Internet mobile station.

11. The Internet mobile switching center system of claim 9, wherein when the identification information of the receiving mobile station belongs to identification information of an Internet mobile station within a public switched telephone network or a wireless Internet network, the call controller transmits the rental Internet Protocol address of the sending Internet mobile station to a gateway system which is connected to the public switched telephone network or the wireless Internet network and transmits an Internet Protocol address of the gateway system to the sending Internet mobile station.

12. The Internet mobile switching center system of claim 9, wherein when the storage unit does not store the identification information of the receiving Internet mobile station, the call controller transmits the identification information of the receiving Internet mobile station to an Internet home location register system to identify an Internet mobile switching center system which manages an Internet base station system managing the receiving Internet mobile station, receives the rental Internet Protocol address of the receiving Internet mobile station from the identified Internet mobile switching center system, transmits the rental Internet Protocol address of the receiving Internet mobile station to the sending Internet base station system, and transmits the rental Internet Protocol address of the sending Internet mobile station to the receiving Internet base station system.

13. A method of providing a wireless Internet mobile communication service, comprising:
(a) when a call requesting message is received from a first Internet mobile station or the call requesting message is transmitted from an Internet mobile switching center system to the first Internet mobile station, allocating a communication channel to the, first Internet mobile station;
(b) allocating a rental Internet Protocol address to the first Internet mobile station and transmitting address allocation information comprising identification information and the rental Internet Protocol address of the first Internet mobile station, and an Internet Protocol address and identification information of a second Internet mobile station which is a corresponding Internet mobile station of the first Internet mobile station to the Internet mobile switching center system;
(c) transmitting the Internet Protocol address of the second mobile station from the Internet mobile switching center system to the first Internet mobile station;
(d) relaying speech Internet Protocol packets between the first Internet mobile station and the second Internet mobile station via a communication channel allocated to the first Internet mobile station; and
(e) when speech communication between the first Internet mobile station and the second Internet mobile station ends or a handoff for the first Internet mobile station and/or the second Internet mobile station is performed, withdrawing the rental Internet Protocol address from the first Internet mobile station and/or the second Internet mobile station and informing the Internet mobile switching center system of the withdrawal of the rental IP address from the first Internet mobile station and/or the second Internet mobile station.

14. The method of claim 13, wherein step (e) comprises:
(e1) measuring an intensity of a signal received from the Internet mobile station;
(e2) when the measured intensity is lower than a predetermined reference intensity, requesting the Internet mobile switching center system for the handoff
(e3) when receiving an instruction to perform the handoff by selecting one of a plurality of adjacent Internet base station systems using the Internet mobile switching center system to manage the Internet mobile station, withdrawing the communication channel and the rental Internet Protocol address from the Internet mobile station; and
(e4)informing the Internet mobile switching center system of the withdrawal of the rental IP address from the Internet mobile station.

15. The method of claim 13, wherein the identification information of the Internet mobile station comprises at least one of a phone number and an electric serial number of the Internet mobile station

16. The method of claim 13, prior to step (a), further comprising transmitting the identification information of the Internet mobile station to an Internet home location register system to register the Internet mobile station.

17. A method of providing a wireless Internet mobile communication service, comprising:
(a) storing first address allocation information which includes identification information of an Internet mobile station received from an Internet base station system and an Internet Protocol address of the Internet base station system and/or second address allocation information which includes identification information of the Internet mobile station, an Internet Protocol address of the Internet base station system, and a rental Internet Protocol address of the Internet mobile station in an address rental database;
(b) searching the address rental database based on identification information of a receiving Internet mobile station received from a sending Internet base station system, transmitting a busy tone to the sending Internet base station system when the address rental database retains an Internet Protocol address and a rental Internet Protocol address of a receiving Internet base station system corresponding to the identification information of the receiving Internet mobile station, instructing the receiving Internet base station system to allocate a communication channel and a rental Internet Protocol address to the receiving Internet mobile station when the address rental database retains only the Internet P address of the receiving Internet base station system corresponding to the identification information of the receiving Internet mobile station, transmits the rental Internet Protocol address of the receiving Internet mobile station from the receiving Internet base station system to the sending Internet base station system, and transmits the rental Internet Protocol address of the sending Internet mobile station to the receiving Internet base station system; and
(c) when the Internet base station system requests withdrawal of the rental Internet Protocol address of the Internet mobile station, deleting the address allocation information corresponding to the Internet mobile station from the address rental database.

18. The method of claim 17, wherein step (c) comprises:
(c1) when receiving the withdrawal request of the rental Internet Protocol address of the first Internet mobile station through the handoff for the first Internet mobile station from the Internet base station system, deleting the address allocation information corresponding to the first Internet mobile station from the address rental database;
(c2) receiving the address allocation information corresponding to the first Internet mobile station from an adjacent Internet base station system which takes over a function of managing the first Internet mobile station and storing the address allocation information in the address rental database;
(c3) transmitting a changed rental Internet Protocol address of the first Internet mobile station to a second Internet mobile station which is a corresponding Internet mobile station of the first Internet mobile station; and
(c4) when receiving the withdrawal request of the rental Internet Protocol address of the first Internet mobile station due to ending of communication from the Internet base station system, deleting the address allocation information corresponding to the first Internet mobile station from the address rental database.

19. The method of claim 17, wherein in step (b), when the identification information of the receiving Internet mobile station belongs to the identification information of an Internet mobile station within a public switched telephone network or a wireless telephone network, the rental Internet Protocol address of the sending Internet mobile station is transmitted to a gateway system which is connected to the public switched telephone network or the wireless telephone network, and an Internet Protocol address of the gateway system is transmitted to the sending Internet mobile station.

20. The method of claim 17, wherein in step (b), when it is determined that the identification information of the receiving Internet mobile station is identification information of an Internet mobile station belonging to a wireless Internet mobile communication network operated by another wireless Internet mobile communication service provider, the identification information of the receiving Internet mobile station is transmitted to an Internet home location register system within the wireless Internet mobile communication network operated by the another wireless Internet mobile communication service provider to identify an Internet mobile switching center system which manages an Internet base station system managing the receiving Internet mobile station, the rental Internet Protocol address of the receiving Internet mobile station is transmitted from the identified Internet mobile switching center system to the sending Internet base station system, and the rental Internet Protocol address of the sending Internet mobile station is transmitted to the receiving Internet base station system.

21. A computer-readable recording medium on which a program is recorded to execute the method of claim 13 in a computer.

22. An Internet mobile communication terminal comprising:
a speech processor which converts an input speech signal into an electric signal or the electric signal into the speech signal;
a keypad which receives a command from a user;
a communication controller which transmits a call requesting message to an Internet base station system that is connected to a wireless Internet network, using a predetermined protocol, is assigned a communication channel and an Internet Protocol address from the Internet base station system to establish a communication path, and transmits its identification information to the Internet base station system in response to a paging signal that is broadcast by the Internet base station system; and
a packet processor which generates Internet protocol packets from digital speech and video data and command data input from a keyboard based on the rental Internet Protocol address allocated by the Internet base station system, and restores the Internet protocol packets to digital speech and video data and character data.

23. The Internet base station system of claim 5, wherein the identification information of the Internet mobile station comprises at least one of a phone number allocated to the Internet mobile station and an electronic serial number allocated to the Internet mobile station.

24. A computer-readable recording medium on which a program is recorded to execute the method of claim 17 in a computer.
